(19) United States
(12) Patent Application Publication
(10) Pub. No.: US 2026/0191133 A1
(43) Pub. Date: Jul. 9, 2026

(54) LINE WINDER FOR LINE TRIMMERS

(71) Applicants: Robert C. Holt, JR., North Canton, OH (US); James G. Stout, Alliance, OH (US)

(72) Inventors: Robert C. Holt, JR., North Canton, OH (US); James G. Stout, Alliance, OH (US)

(21) Appl. No.: 19/013,262

(22) Filed: Jan. 8, 2025

(51) Int. Cl. A01D 34/416; A01D 101/00; B65H 54/40

(52) U.S. Cl. CPC A01D 34/4163; B65H 54/40; A01D 2101/00

(57) ABSTRACT

A line winder for a line trimmer has an annular body core that has ramped lugs extending from a first surface of the core. The ramped lugs are configured for mating engagement with ramped pockets of a bump feed mechanism of the line trimmer. The annular body core has a plurality of legs positioned circumferentially thereabout, such legs having ends that extend beyond the surface from which the ramped lugs extend. Between pairs of the legs, an indented hand digit recess is provided for receipt of fingers and thumbs of an operator. Rotational motion of the annular body core drives a spool mechanism within the bump feed mechanism to wind line onto a spool.

### TECHNICAL FIELD

The invention herein resides in the art of line trimmers and, more particularly, to winding mechanisms for the line received by and dispensed from the head of the trimmer. More particularly, the invention relates to a tool for facilitating the winding of line onto a spool or spools retained by the trimmer head. Specifically, the invention relates to a tool for engaging a winding mechanism of a line trimmer that enhances the torque that can be applied to the winding mechanism and the ease by which the torque can be applied by the hand of a user.

### BACKGROUND OF THE INVENTION

Line trimmers are now commonly known and used by homeowners and professional landscapers alike for trimming and edging grass and other vegetation in otherwise hard to reach locations. Typically, a line trimmer includes a head at the end of a rod, the head being caused to rotate at a rather high speed by a gas engine or battery powered motor. The head typically contains a spool or spools of line. The line exits the rotating head at one or more apertures, establishing cutting surfaces along the edges of the line as the line rotates.

The head typically includes a feeding mechanism to allow the line to be fed from the head to maintain a sufficient length to establish an effective cutting surface during operation. As the line wears and is fed from the head, the line ultimately becomes fully dispensed and there is a need for adding new line to the spool or spools.

In previous line trimmers, the spool or spools were typically removed from the head and the line was hand wrapped upon the spools. The spools were then replaced within the head and the lines draw outwardly from the head through dispensing apertures. The spools would then be locked in place by a cover and the line trimmer could then be returned to use.

The replacement of the line in line trimmers was previously a time-consuming task and somewhat complex, requiring the removal of the spools, the independent rewinding of the spools, and then the replacement and securing of the spools within the head. These processes would also require the cutting of specified links of the cutting line for individual placement and wrapping upon the associated spools.

Presently, there are line trimmers that have eliminated the need for removal of the spool or spools and which accommodate the receipt of a single length of cutting line that can be wound upon a spool without any disassembly of the head, greatly reducing the time and complexity associated with previous line replacements. Presently, line trimmers exist that can receive a single length, on the order of 26 feet, to be rewound on a single spool and dispensed from opposed apertures in what is intended to be a simple operation. With these trimmers, a single length of cutting line is passed from one dispensing aperture, through the cutting head, and out of a second diametrically opposed aperture until equal lengths extend from the head on opposite sides thereof. Operators then use their hand digits to be received by arcuate ramped pockets formed in a bottom surface of the dispensing head to wind a cutting line onto a dispensing spool received therewithin. The operator's hand digits must first depress the bottom surface of the dispensing head to disengage a spring-biased brake on the spool mechanism to accommodate the winding of the cutting line. Only the tips of the hand's digits are received by the arcuate ramped pockets, which are disposed about a significantly small circle. This makes the disengagement of the brake and the winding operation difficult to perform. Indeed, the difficulty tends to frustrate the intended ease of use and operation. The pockets are small, receive only the tips of the digits of the user's hands, and are spaced about a circle of a small radial dimension. Also, the force required to disengage the brake is significant. Accordingly, the torque that can be implemented to wind the spool is reduced from that which would be preferred for efficiency.

There is a need in the art for a line winder that may be used in association with present line trimmers that accommodates ease and effectiveness of use and which does so in an effective and cost-efficient manner.

### DISCLOSURE OF INVENTION

In light of the foregoing, it is an aspect of the invention to provide a line winder for a line trimmer that enhances the torque that can be applied to a line-winding mechanism of the line trimmer.

Another aspect of the invention is the provision of a line winder for a line trimmer that engages substantial portions of the digits of a user's hand and which accommodates ease of application of rotational force.

Still a further aspect of the invention is the provision of a line winder for line trimmers that can be easily engaged by the palm of a user's hand rather than only the tips of the digits of the hand.

A further aspect of the invention is the provision of a line winder for line trimmers that is simple in construction, easy to use, and inexpensive to manufacture.

The foregoing and other aspects of the invention that will become apparent is the detailed description proceeds are achieved by a line winder for a line trimmer having a head, the head having a housing receiving and maintaining a spool mechanism for receiving, maintaining and dispensing cutting line, the housing having diametrically opposed apertures through which extend a continuous length of the cutting line, the line trimmer further having a bump feed mechanism for dispensing the cutting line through said apertures, the bump feed mechanism having ramped pockets for receiving digits of an operator's hand for applying torque to the bump feed mechanism for winding the line onto the spool mechanism, said line winder comprising: an annular body core having a plurality of ramped lugs extending from a first surface thereof, said ramped lugs being configured for mating engagement with said ramped pockets; a plurality of legs positioned circumferentially about said annular body core, said legs having ends extending beyond said first surface; and a plurality of indented hand digit recesses, one such hand digit indented recess between each of pairs of said legs.

Additional aspects of the invention are achieved by a method for winding line onto a line trimmer having a head, the head having a housing receiving and maintaining a spool mechanism for receiving, maintaining and dispensing cutting line, the housing having diametrically opposed apertures through which extend a continuous length of the cutting line, the line trimmer further having a bump feed mechanism for dispensing the cutting line through said apertures, the bump feed mechanism having ramped pockets for receiving digits of an operator's hand for applying torque to the bump feed mechanism for winding the line onto the spool mechanism, said method comprising: bringing into mating engagement with said ramped pockets a plurality of ramped lugs of an annular body core, said plurality of ramped lugs extending from a first surface of said annular body core; engaging digits of a user's hand with a plurality of indented hand digit recesses about a circumference of said annular body core; depressing said bump feed mechanism by forceful axial engagement with said annular body core releasing said spool mechanism for free rotation; and rotating said annular body core while depressing said bump feed mechanism, causing said spool mechanism to rotate.

### DESCRIPTION OF DRAWINGS

For a complete understanding of the various aspects and structures of the invention, reference should be made to the following detailed description and accompanied drawings, wherein:

FIG. 1 is a perspective view of a line trimmer head of the prior art, showing the underside of the head;

FIG. 2 is a perspective view of the bottom of the line winder tool of the invention;

FIG. 3 is a perspective view of the top of the line winder tool of the invention; and

FIG. 4 is a perspective view of the line winder tool of the invention in engagement with the head of the prior art line trimmer of FIG. 1.

### DETAILED DESCRIPTION OF PREFERRED EMBODIMENT

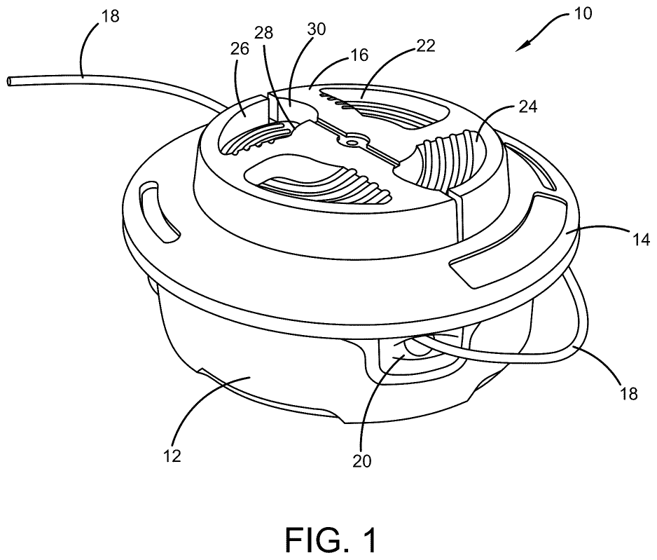

Referring now to the drawings and more particularly FIG. 1, there is shown a bottom perspective view of a line dispensing head for a line trimmer designated by the numeral 10. The head 10 is prior art to the invention herein. The head 10 comprises a housing 12 that receives and maintains a spool mechanism for receiving, maintaining, and dispensing cutting line 18. An annular rim cap 14 is snapped fit to the housing 12 for retaining a spring-biased bump feed mechanism to enable cutting line 18 to be dispensed through apertures 20 from the side wall of the housing 12. Typically, the apertures 20 are diametrically opposed about the can-shaped housing 12. The bump feed mechanism serves to disengage a brake on the spool mechanism to allow the spool mechanism to become free wheeling to effect the dispensing of cutting line 18 to keep an adequate cutting length rotating with the head 10 during operation.

The exposed face of the bump feed mechanism 16 is characterized by arcuate ramped pockets 22, there preferably being 4 such pockets uniformly spaced thereabout, as shown. The arcuate ramped pockets 22 are provided for receipt of the digits of a user's hand, typically accommodating up to three finger tips and a thumb tip. Each of the pockets 22 is characterized by a grooved downwardly ramped bottom surface 24 and a pair of inwardly sloped arcuate walls 26, 28 that extend from the bottom surface 24 on opposite sides thereof. A back wall 30 characterizes the end of each arcuate ramped pocket 22 as shown.

The head 10 is configured to receive and dispense significant lengths of cutting line 18. Known heads may receive on the order of 26 feet of 2.4 mm cutting line, passed into a first aperture 20, through a take-up spool within the housing 12, and then out an opposite aperture 20 until approximately 13 feet of cutting line 18 are presented on each of opposite sides of the head 10.

The arcuate ramped pockets 22 are adapted to receive the ends of digits of a human hand, most typically the tips of a thumb and three fingers. With the pockets 22 so engaged, the operator may then forcefully depress the exposed face of the bump feed mechanism 16, to release a brake and cause the spool mechanism to become free wheeling. While maintaining such depression to keep the brake released, the operator may then rotate the spring-biased bump feed mechanism 16, which in turn rotates the released interior spool, to wrap the line up on the dispensing spool, resulting in a line trimmer then ready for normal use.

While the concept of the prior art dispensing head 10 is speed and ease of refilling the spool within the housing 12 with cutting line 18, it has been found that the pockets 22 are not given to the ease of receipt of typical human digits that only impact small portions of the receiving pockets with the tips of the digits, and with each digit contacting the pocket differently. It has been found that the digits (fingers and thumb) often slip from the pockets 22 and are, in any event, routinely removed and replaced within the pockets as the line wraps. Moreover, the amount of force that can be applied to release the brake and torque that can be applied by the tips of the digits of one's hand, while maintaining the depression of the exposed face of the bump feed mechanism 16, is limited by anatomy. But, there is a lack of comfort experienced by the tips of the digits in use. Further, it has been found that the pockets 22 often fill with abraded vegetation and the like, making entry therein with the tips of fingers and a thumb quite difficult. Such can further limit the amount of force and torque that can be applied by the digits, further making the use of the prior art a frustrating exercise.

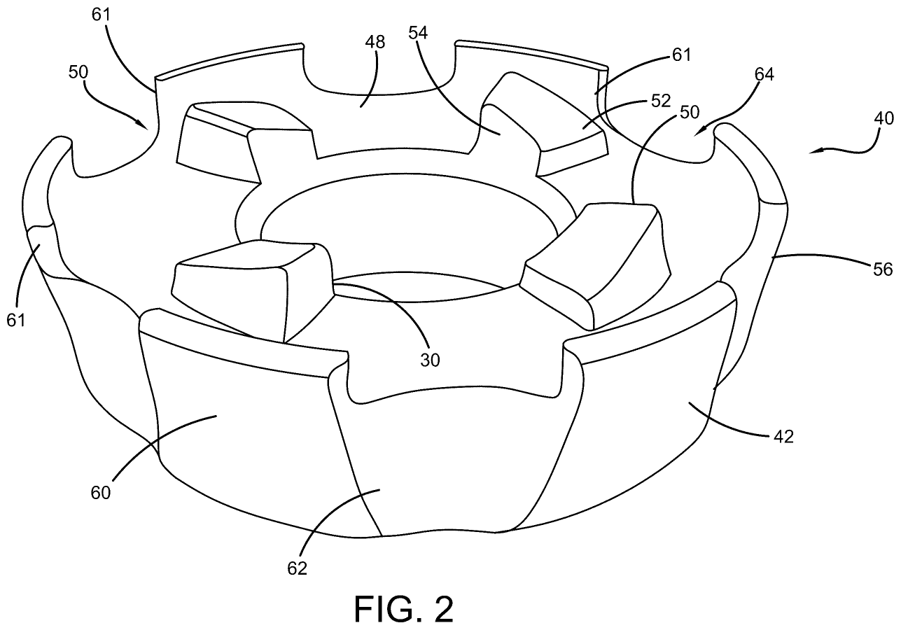

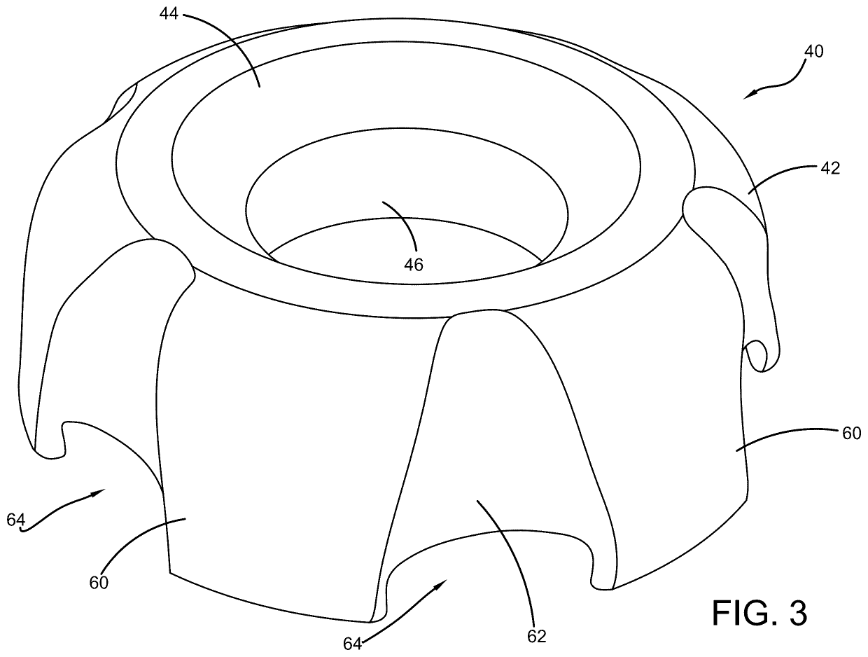

With reference now to FIGS. 2 and 3, bottom perspective and top perspective views are respectively shown of a line winder 40 made in accordance with the instant invention. As shown, the line winder 40 has a annular body core 42, an annular rim 44, an annular inner wall 46, and an annular base 48. Arcuate ramped lugs 50, extending from the base 48, have grooved upwardly ramped surfaces 52 to engage with and receive the grooved downwardly ramped bottom surface 24 of the pockets 22. The ramped lugs 50 further have outwardly sloped arcuate walls 54, 56 to respectively engage the inwardly sloped arcuate walls 26, 28 of the arcuate ramped pockets 22, respectively. Finally, a back wall 58 characterizes each of the lugs 50 and is adapted to engage the back wall 30 of the pockets 22. In sum, it will be appreciated that the lugs 50 are configured and spaced to be matingly received by the ramped pockets 22.

As further shown, in FIGS. 2 and 3, the line winder 40 further includes a uniformly spaced legs 60 about the outer circumference thereof, with indented curved recesses 62 defined between each pair of legs. The recesses 62 are shorter than the legs 60 to provide openings 64, as shown.

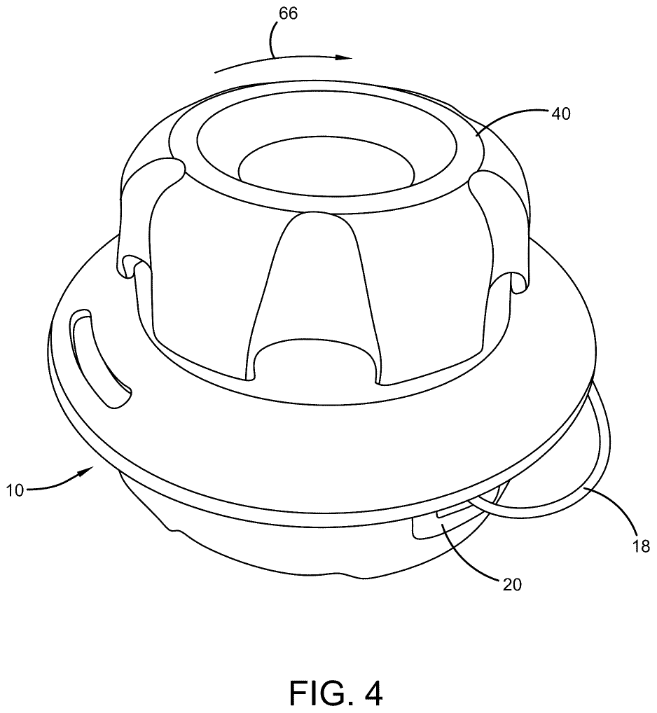

Referring now to FIG. 4, it can be seen that the line winder 40 may be received by the line trimmer head 10 by receipt of the lugs 50 within the ramped pockets 62 and that turning of the spring-biased bump mechanism 16 may be achieved when the line winder 40 is rotated clockwise as shown by the arrow 66. The forceful engagement of the pockets 22 by the back wall 58 of the lugs 50 causes such rotation, and the resultant rotation of the spool within the housing 12. Concurrently with the rotation, downward forceful engagement between the grooved ramped surfaces 52 of the line winder 40 with the grooved ramped surfaces 24 of the head 10 releases the brake of the spring-biased bump feed mechanism 16 to accommodate such rotation.

The forceful movement of the line winder 40 is achieved by a sequence of repeated steps of the engagement of the fingers and thumb with the recesses 62 in the side wall of the line winder 40 to grip the line winder 40 circumferentially, while accommodating depression by the user's palm and/or fingers against the top of the annular body core 42. This depresses the spring-biased bump mechanism 16 to release the brake as torque is applied by the user's fingers and thumb to rotate the line winder 40 to wind the line through a necessary number of those repeated steps. Preferably, the user employs three fingers and a thumb in the recesses 62 to rotate the line winder 40, although any combination may be used. The rotational engagement between the back walls 58 and 30 of the ramped lugs 50 and ramped pockets 22 provide more torque than just the implementation of finger and thumb tips in the pockets 22 as contemplated by the prior art. The line winder 40 has a greater diameter, and thus torque arm, than the pockets 22, and the fingers and thumb, imparting force to the line winder 40, are capable of imparting more force than simply finger and thumb tips within the ramped recesses. Similarly, simultaneous depression of the bump feed mechanism 16 by the user's forceful engagement with the annular body core 42 facilitates disengagement of the brake of the spool mechanism to accommodate the winding of lines. Moreover, the comfort level for the user is greatly enhanced, allowing for more comfortable and faster use.

It has been found that digits typically would slip from the pockets, while the recesses 62 accommodate a greater torque arm and more comfortable engagement than the prior art itself. Indeed, the line winder 40 contemplates full hand grip about the circumference of the annular body core 42 with non-slip engagement with the recesses 62. Moreover, the line winder 40 reduces user fatigue, strain and injury possibilities due in large part to the fitting of the lugs 50 within the pockets 22 and the overhanging engagement of the extended bottoms 61 of the legs 60 with the side wall of the spring-biased bump feed mechanism 16.

Thus it can be seen that the aspects of the invention have been achieved by the structure presented above. While in accordance with the patent statutes, only the best known and preferred embodiment of the invention has been presented and described in detail, the invention is not limited thereto or thereby. Accordingly, for an appreciation of the true scope and breadth of the invention, reference should be made to the following claims.

What is claimed is:

1. A line winder for a line trimmer having a head, the head having a housing receiving and maintaining a spool mechanism for receiving, maintaining and dispensing cutting line, the housing having diametrically opposed apertures through which extend a continuous length of the cutting line, the line trimmer further having a bump feed mechanism for dispensing the cutting line through said apertures, the bump feed mechanism having ramped pockets for receiving digits of an operator's hand for applying torque to the bump feed mechanism for winding the line onto the spool mechanism, said line winder comprising:
an annular body core having a plurality of ramped lugs extending from a first surface thereof, said ramped lugs being configured for mating engagement with said ramped pockets;
a plurality of legs positioned circumferentially about said annular body core, said legs having ends extending beyond said first surface; and
a plurality of indented hand digit recesses, one such hand digit indented recess between each of pairs of said legs.

2. The line winder for a line trimmer according to claim 1, wherein said first surface is a flat surface.

3. The line winder for a line trimmer according to claim 2, wherein said plurality of ramped lugs are uniformly spaced about said first surface.

4. The line winder for a line trimmer according to claim 3, wherein each said ramped lug has an upwardly ramped surface, a pair of outwardly sloped arcuate walls, and a back wall.

5. The line winder for a line trimmer according to claim 4, wherein said upwardly ramped surface is grooved.

6. The line winder for a line trimmer according to claim 3, wherein said ends of said legs are positioned alongside the bump feed mechanism.

7. The line winder for a line trimmer according to claim 3, wherein said hand digit recesses are configured to receive selected ones of fingers and thumbs of the operator.

8. A method for winding line onto a line trimmer having a head, the head having a housing receiving and maintaining a spool mechanism for receiving, maintaining and dispensing cutting line, the housing having diametrically opposed apertures through which extend a continuous length of the cutting line, the line trimmer further having a bump feed mechanism for dispensing the cutting line through said apertures, the bump feed mechanism having ramped pockets for receiving digits of an operator's hand for applying torque to the bump feed mechanism for winding the line onto the spool mechanism, said method comprising:
bringing into mating engagement with said ramped pockets a plurality of ramped lugs of an annular body core, said plurality of ramped lugs extending from a first surface of said annular body core;
engaging digits of a user's hand with a plurality of indented hand digit recesses about a circumference of said annular body core;
depressing said bump feed mechanism by forceful axial engagement with said annular body core releasing said spool mechanism for free rotation; and
rotating said annular body core while depressing said bump feed mechanism, causing said spool mechanism to rotate.

9. The method for winding line onto a line trimmer according to claim 8, wherein said steps of depressing said bump feed mechanism and rotating the annular body core are incrementally repeated until a desired amount of the line is wrapped onto the spool mechanism.
